(19) United States
(12) Patent Application Publication
(10) Pub. No.: US 2002/0075511 A1
(43) Pub. Date: Jun. 20, 2002

(54) Process for visualizing geographic sites

(76) Inventor: Ivan Lorne, Marseille (FR)

Correspondence Address: IP Department, Schnader Harrison Segal & Lewis, 36th Floor, 1600 Market Street, Philadelphia, PA, 19103, US

(21) Appl. No.: 09/768,384

(22) Filed: Jan. 19, 2001

Related U.S. Application Data
(63) Continuation of application No. PCT/FR00/01401, filed on May 22, 2000.

(30) Foreign Application Priority Data
May 21, 1999 (FR) 99/06522

(51) Int. Cl. G06F 15/00

(52) U.S. Cl. 358/1.15

(57) ABSTRACT

The invention relates to a process for dynamically geographically representing distinctive elements including cartographic data including issuing a query to a server, reading general configuration files and files specific to a data base by the server, creating an image file of a map to be created by the server, generating a HTML page by the server of a model file in which cartographic markers or meta-tags are replaced by their values, and sending the HTML page generated by the server.

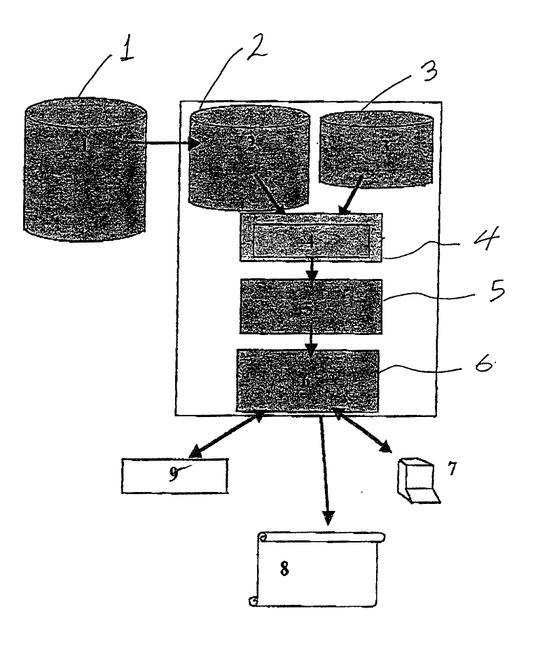

### RELATED APPLICATION

This is a continuation of International Application No. PCT/FR00/01401, with an international filing date of May 22, 2000, which is based on French Patent Application No. 99/06522, filed May 21, 1999.

### FIELD OF THE INVENTION

This invention pertains to the field of geographic localization by superposition of cartographic data.

### BACKGROUND

It is known to add a layer of localizing information to facilitate reference positioning on city maps by means of icons representing the common reference sites such as public or commercial sites. For example, at a scale of 1/10,000 (1 centimeter represents 10 meters in reality), two reference points which are 100 meters apart on the ground would be materialized by two icons which are 10 centimeters apart on the map. However, at a scale of 1/100,000 (1 centimeter represents 100 meters in reality), the same two reference points which are 100 meters apart on the ground would be materialized by two icons which are 1 centimeter apart on the map.

In this latter case, if the icons are larger than 0.1 cm, they overlap each other on the map. The map then becomes confusing and difficult to read because it is overloaded. Thus, it would be advantageous to have a simple means to provide reference positioning of visual elements on a map and to make it possible to find precise information elements on a map. Known in the state of the art is U.S. Pat. No. 5,790,121, which describes a cartographic interface.

### SUMMARY OF THE INVENTION

The invention relates to a process for dynamically geographically representing distinctive elements including cartographic data including issuing a query to a server, reading general configuration files and files specific to a data base by the server, creating an image file of a map to be created by the server, generating a HTML page by the server of a model file in which cartographic markers or meta-tags are replaced by their values, and sending the HTML page generated by the server.

The invention also relates to an interface for implementing the process.

### BRIEF DESCRIPTION OF THE DRAWING

Better comprehension of the invention will be provided by the detailed description below of an example of implementation.

The drawing shows schematically the general architecture of the process for the creation of maps enabling responses to specific queries.

### DETAILED DESCRIPTION

The invention pertains to a process for the dynamic geographic representation of distinctive elements by superposition on a support comprising cartographic data and means for selecting the scale of representation, characterized in that it comprises a step in which a client issues a query, a step involving reading by the server of the general configuration files and files specific to the data base, a step of creation of an image file of the map to be created by the server, a state of execution by the server of a model file of the HTML page result in which the cartographic markers are replaced by their values and a step in which the server issues the HTML page that has been generated.

According to a variant, the invention concerns a process for the dynamic geographic representation of distinctive elements by superposition on a support comprising cartographic data and means for selecting the scale of representation in which the distinctive elements are associated with classification variables corresponding to the display requests and the scale of representation. These distinctive elements can consist of icons or of any visual elements such as text or colored signs. In a general manner, the visual elements are associated with an assembly of information to which the classification variables can make reference.

The distinctive elements are preferentially displayed at a scale that is predefined by a visibility distance. In an advantageous variant, the density of the displayed elements is measured and the visibility distance of the elements is modified on the basis of a predefined density value. The display size of the distinctive elements is advantageously proportional to the ratio of the visibility distance value to the scale value.

In a variant, the classification variables are organized into hierarchies. It is then possible to performance a lexical search of the display requests. The visibility distance, the base size of the displayed elements and the classification of the elements are advantageously defined and these elements are placed on a cartographic representation.

The invention also pertains to the interface enabling implementation of the processes according to the invention.

Turning now to the drawing, an information data base (1) is associated with an assembly of distinctive elements (2) which are placed on the cartographic representations the data for which are entered in the memory of a specific data base (3).

The process of the invention makes it possible to associate the different cartographic elements responsive to a specific query (4) and to generate graphical interfaces responsive to a predefined type of query (5). A specific interface (6) then makes it possible to place the interface according to the information on a data network (7), to print geographic maps (8) or to transmit this information to any communication system (9).

The selection of the reference point icons to display at a given scale depends on a display algorithm based on the display rules predefined by the classification of the information attached to the icons. At each map scale, an optimal number of icons is displayed to establish a compromise between: presenting a maximum number of reference points and avoiding overloading the map to prevent overlaps.

In a particular implementation, the icon management principle is based on the coupling of:

A table classifying the totality of the services in an original order;

A display algorithm based on rules enabling the optimal selection of the reference point icons appearing at a given scale.

The services are classified in a hierarchical manner by means of a table of services comprising an identifier number incremented by base 10. The following table provides an example:

| | |
|---|---|
| Housing: | 40000 |
| Hotels: | 41000 |
| Three-star hotels: | 41130 |
| Four-star hotels: | 41140 |
| Real estate: | 42000 |
| Real estate for rent: | 42100 |
| Real estate for sale: | 42200 |
| Monuments: | 81000 |
| Fountains: | 82000 |
| Parking lots: | 83000 |

This classification by services enables execution of very simple queries.

The visualization system is based on an algorithm that associates the file names of the services with the icon registrations. The file names are constructed from the service number and a specific name linked to the icon. The distinctive characteristic of this algorithm is to enable obtaining the icon which is the most suitable for a service in the case in which the icon does not exist. If the file of an icon does not exist, the algorithm selects the icon corresponding to the hierarchically higher service.

The algorithm is recursive and makes it possible to climb several base 10 steps until a pictogram name is found. The algorithm also makes it possible to couple the name of the icon file with a specific field linked to a unit of information which enables differentiation of two identical service numbers. The device also enables providing the address of a site on the Internet for associating an icon with an Internet site.

The cartographic search engine uses a vectorial technology which provides easy navigation at various scales and makes it possible to visualize the details of a street or to obtain a general view of the main roads of an urban area. The maps of the urban area can be displayed at different scales. The invention ensures easy positioning due to the optimized display of icons representing the reference points and the Internet sites.

For each interrogation, the cartographic search engine generates a plan from a map and a data base. The cartographic search engine, for example, enables searching for hotels close to a specific zone. The result appears on the screen in the form of icons placed on the map. Each icon can be clicked to send the user to the Internet page of an establishment (in the case of a hotel, the page can describe the rooms or even propose room reservations, etc.). Internet surfers having a site can add without charge their icon onto the cartographic search engine and insert maps in their sites.

A cartographic search engine makes it possible to not only reference the home page of a site, but also its information at a granular level (all of the real estate advertisements in a district, for example). In addition, this array of information is referenced with criteria that are specific to each sector (for example, the number of stars for the hotels) which enables a finer processing. The other search engines merely contain a site's home page in their memory.

Moreover, a cartographic search engine makes it possible to federate the data bases of multiple providers (for example, data bases of real estate advertisements) and to distribute them to other Internet sites. Finally, the cartographic search engine makes it possible to place icons on the maps in a firm's colors.

A specific program enables remote placement of the icons from a cartographic program which contains locally the vectorial data bases (so as to avoid downloading large files) and dialog with the map server.

This program implements a dialog with the map server by means of an array of protocols based directly on the HTTP protocol, thereby providing the server with great flexibility such that it can implement dialogs simply with numerous applications and different platforms. The queries (list, add, suppression, modification) are made by simple SQL queries (text file encapsulated by the HTTP protocol). The responses are based on transmitting textual data (encapsulated by the HTTP protocol) or the registrations and fields are separated by a pair of markers. Authentications are implemented via encrypted parameters and firewall mechanisms proprietary to the server.

The functional diagram of a query is as follows:

Step 1: The client issues a parameterized CGI query (bdd, metric coordinates, SQL query, etc.).

Step 2: The server reads various general configuration files and files specific to the data base.

Step 3: The server performs a SQL query on the data base and creates an image file, for example a GIF, of the map to be created.

Step 4: The server executes a model file of the HTML page result in which it replaces the cartographic meta-tags or markers with their values. This system thus enables easy modification of the HTML pages comprising the query results.

Step 5: The server sends the HTML page that has been generated.

The invention is applicable to all of the flow charts, organization charts, plans of buildings and networks (hydrographic, electric, circulation, and the like) of a city, state, province, county or country, and by extension to all representations constituted by an array of segments representing wires, cables, pipes, corridors, streets, avenues, highways as well as a legend describing the names of each of these segments.

What is claimed is:

1. A process for dynamically geographically representing distinctive elements including cartographic data comprising:
issuing a query to a server;
reading general configuration files and files specific to a data base by the server;
creating an image file of a map to be created by the server;
generating a HTML page by the server of a model file in which cartographic markers or meta-tags are replaced by their values; and
sending the HTML page generated by the server.

2. The process in accordance with claim 1, wherein the elements are associated with classification variables corresponding to display requests and to a scale of representation.

3. The process according to claim 1, wherein the elements are displayed based on a scale that is predefined by a visibility distance.

4. The process according to claim 2, wherein the elements are displayed based on a scale that is predefined by a visibility distance.

5. The process according to claim 3, wherein density of the displayed elements is measured and the visibility distance of said elements is modified on the basis of a predefined density value.

6. The process according to claim 4, wherein density of the displayed elements is measured and the visibility distance of said elements is modified on the basis of a predefined density value.

7. The process according to claim 2, wherein display size of the elements is proportional to a ratio of visibility distance value to a scale value.

8. The process according to claim 5, wherein display size of the elements is proportional to a ratio of visibility distance value to a scale value.

9. The process according to claim 6, wherein display size of the elements is proportional to a ratio of visibility distance value to a scale value.

10. The process according to claim 2, wherein the classification variables are organized into hierarchies.

11. The process according to claim 1, further comprising performing a lexical search of display requests.

12. The process according to claim 3, wherein the visibility distance, base size of the elements and classification of the elements are defined and the defined elements are placed on a cartographic representation.

13. An interface for implementing the process according to claim 8.
